(19) United States
(12) Patent Application Publication
(10) Pub. No.: US 2026/0045970 A1
(43) Pub. Date: Feb. 12, 2026

(54) METHOD AND MULTI-USER UPLINK RECEIVER FOR DIFFERENT TYPES OF MULTIPLE ACCESS SCHEMES

(71) Applicant: Indian Institute of Technology Kharagpur, Kharagpur (IN)

(72) Inventors: B.V. Sudhakar Reddy, Kharagpur (IN); Chaithanya Velampalli, Kharagpur (IN); Suvra Sekhar Das, Kharagpur (IN)

(21) Appl. No.: 18/963,983

(22) Filed: Nov. 29, 2024

(30) Foreign Application Priority Data
Aug. 8, 2024 (IN) 202431060025

(51) Int. Cl. H04B 7/00; H04L 1/00; H04L 25/03; H04L 27/38

(52) U.S. Cl. CPC H04B 7/002; H04L 1/0054; H04L 25/03006; H04L 27/38; H04L 2025/03433

(57) ABSTRACT

Provided is a method (300) and a successive interference cancellation (SIC) based multi-user uplink receiver (200) for multi-user uplink transmission. The method comprises receiving (302) signal of one or more multiple-access (MA) scheme waveforms by a plurality of antennas (202.1, . . . , 202.R) from one or more users. The method further comprises determining (304) one or more effective channel matrices corresponding to the plurality of antennas. Thereby, the method comprises performing (306) channel equalization for signal received in a corresponding antenna by an effective channel matrix. Furthermore, the method comprises combining (308) the channel equalized signal. Subsequently, the method comprises detecting (310) Correctly Decoded Code Blocks (CCBs) and Wrongly Decoded Code Blocks (WCBs). Upon detecting CCBs and WCBs, the method comprises performing (312) the SIC on received signals from one or more users until all WCBs are converted to CCBs or a maximum number of threshold iterations are completed.

### TECHNICAL FIELD

The present disclosure relates to wireless communication. Particularly, but not exclusively, the present disclosure is directed towards a multi-user uplink receiver for different types of multiple access schemes with Orthogonal Time Frequency Space (OTFS), Orthogonal Frequency Division Multiplexing (OFDM), Orthogonal Time Sequency Multiplexing (OTSM), and Single carrier (SC) waveforms.

### BACKGROUND

Conventional techniques disclose Forward Error Correction (FEC) based Successive Interference Cancellation (SIC) receivers. Such receivers utilize FEC decoding to reconstruct a portion of the originally transmitted signal using correctly received code blocks (CCBs). Then, they remove interference caused by this portion on the part of the transmitted signal corresponding to wrongly received code blocks (WCBs). After interference cancellation, the resulting signal, free from interference, undergoes channel equalization to detect the WCBs. During the process, it is possible that some WCBs, which are incorrect before interference cancellation, become correct and are included in the set of CCBs. Using the increased CCBs, more interference can be cancelled in the received signal, potentially leading to more WCBs being corrected. This iterative process continues, with each iteration increasing the number of CCBs.

In conventional methods, channel matrix used for equalization depends only on the grid parameters. It is fixed and independent of the number of users and their transmitted data symbols. The size of the channel matrix can be reduced when fewer users are present. Channel equalization yields better performance with an appropriately sized channel matrix rather than a fixed, full-size matrix.

Particularly, in conventional patent literature, Yakun Sun et al. in “Adaptive successive interference cancellation receivers”, U.S. Pat. No. 8,949,683B1, 2015, discloses a system and method for successive interference cancellation. Yakun Sun et al. disclose an FEC based SIC receiver, however, no description of handling multiple users related is disclosed herein.

In another conventional patent literature, Hong Jik Kim et al. “Methods and apparatus for successive interference cancellation (SIC)” U.S. Pat. No. 11,223,441B1, 2022, discloses, using FEC technique, receiver cancelling interference from non-targeted users on targeted users received signal Z.

In another conventional patent literature, Marcos Tavares et al. “Successive interference cancellation and multi-user minimum mean square channel estimation based on soft decoding information” U.S. Pat. No. 10,484,210B2, 2019 discloses FEC based SIC receiver. The FEC based SIC receiver decodes the users' data in a sequential manner.

In another conventional non-patent literature, B. V. S. Reddy, C. Velampalli and S. S. Das, “Performance Analysis of Multi-User OTFS, OTSM, and Single Carrier in Uplink,” in IEEE Transactions on Communications, vol. 72, no. 3, pp. 1428-1443 Mar. 2024 discloses FEC based SIC receiver. This receiver processes the received signals only in time domain.

However, for all the conventional techniques, the channel matrix used for equalization depends only on the grid parameters. The channel matrix is fixed and independent of the number of users and their transmitted data symbols.

Therefore, there is a requirement to dynamically determine size of the channel matrix based on the number of users and their transmitted data symbols to eliminate need for a full-size matrix each time. The present disclosure overcomes one or more limitations of the sensing platform as mentioned hereinabove.

### SUMMARY

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

According to one or more embodiments, the present disclosure relates to a method of successive interference cancellation (SIC) in a multi-user uplink receiver. The method comprises receiving signal of one or more multiple-access (MA) scheme waveforms from one or more users by a plurality of antennas of the multi-user uplink receiver at a base station or access point. The received signal in each antenna of the plurality of antennas relates to a composite signal from one or more users. The method further comprises determining one or more effective channel matrices corresponding to the plurality of antennas. Each of the one or more effective channel matrices for a corresponding antenna of the plurality of antennas is determined based on a type of the MA scheme waveforms from the one or more users in the corresponding antenna and a length of the received signal in the corresponding antenna from the one or more users. Furthermore, the method comprises performing channel equalization for signal received in the corresponding antenna from one or more users. The channel equalization is performed by a channel equalization technique using each of the one or more effective channel matrices. Thereby, the method comprises combining channel equalized signal using an Equal Gain Combining (EGC) technique from the plurality of antennas to form a combined estimated effective transmission signal from the one or more users. Upon forming the combined estimated effective transmission signal, the method comprises detecting Correctly Decoded Code Blocks (CCBs) and Wrongly Decoded Code Blocks (WCBs) of the received signal from each user of the one or more users. The method further comprises performing the SIC on received signals from one or more users until all WCBs are converted to CCBs or a maximum number of threshold iterations are completed.

According to one or more embodiments, for detecting CCBs and WCBs of each user, the method comprises performing segregation on the EGC combined channel equalized signals to retrieve effective symbol vector transmitted by the corresponding user. Further, the method comprises computing Log Likelihood Ratio (LLR) values from the retrieved symbol vector upon performing segregation on the EGC combined channel equalized signals. Furthermore, the method comprises decoding, by a Low-Density Parity-Check (LDPC) decoder, each bit of the LLR values to retrieve code blocks transmitted by the corresponding user. Upon decoding each bit of the LLR values, the method comprises identifying the CCBs and the WCBs based on the LDPC decoded values for each user. Thereby, the method comprises regenerating the transmitted data symbol vector using the CCBs for each user for performing SIC in next iteration.

According to one or more embodiments, for regenerating the transmitted data symbol vector by using the CCBs in each of subsequent iterations, the method comprises computing the regenerated symbol vector for each user to form a regenerated effective symbol vector. The method further comprises generating a signal for cancelling interference in the corresponding received signal at each antenna by applying a corresponding effective channel matrix to the regenerated effective symbol vector in each subsequent iteration. The corresponding effective channel matrix relates to a channel effect during transmission of the wireless signal. The method further comprises cancelling interference from data symbols of the received signal by subtracting the generated signal from the received signal. Moreover, the method comprises updating the corresponding channel equalization matrix based on the data symbols of the regenerated effective symbol vector upon cancelling the interference.

Furthermore, the method comprises performing channel equalization on interference free signal of each antenna for correcting code blocks in the received signal by the channel equalization technique using the updated corresponding channel equalization matrix. Thereby, the method comprises combining channel equalized signal from each antenna of the one or more antennas using the EGC technique to form interference free combined estimated effective transmission signal from the one or more users. Further, the method comprises performing segregation on the EGC combined channel equalized signals to retrieve effective symbol vector transmitted by the corresponding user. Thereafter, the method comprises computing LLR values from the retrieved symbol vector upon performing segregation on the EGC combined channel equalized signals. Further, the method comprises decoding selectively each bit of the LLR values corresponding to the WCBs of the previous iteration by the LDPC decoder to retrieve all code blocks transmitted by the corresponding user. Upon decoding each bit of the LLR values corresponding to the WCBs of the previous iteration, the method comprises identifying the CCBs and the WCBs based on the LDPC decoded values for each user. Furthermore, the method comprises regenerating data symbols from the transmitted data symbol vector by the one or more users from each bit of correctly decoded blocks in combination with previously detected CCBs.

According to one or more embodiments, the corresponding channel equalization matrix is updated by nullifying columns of the effective channel matrix whose indices match with reconstructed Quadrature Amplitude Modulation (QAM) symbols in the regenerated effective symbol vector.

According to one or more embodiments, a semi-orthogonal matrix is used for transmitting QAM symbols as per allocated resources during transmission of the wireless signal, wherein the semi-orthogonal matrix is pre-defined based on the type of MA scheme.

According to one or more embodiments, receiving wireless signal of the one or more MA scheme waveforms further comprises removing cyclic prefix from the received wireless signals for further processing.

According to one or more embodiments, for determining one or more effective channel matrices corresponding to one or more receive antennas, the method further comprises generating an upsampling matrix, a cyclic forward permutation matrix, and a rectangular matrix with ones on the main diagonal axis and zeros elsewhere based on type of MA scheme and a number of symbols transmitted by the corresponding user. The method further comprises determining one or more effective channel matrices based on the upsampling matrix, the cyclic forward permutation matrix, and the rectangular matrix.

According to one or more embodiments, size of the one or more effective channel matrices varies based on maximum number of symbols transmitted by a user among one or more users, and total number of users transmitting signal to the plurality of antennas.

According to one or more embodiments, the one or more MA scheme waveforms relate to any one of Orthogonal Time Frequency Space (OTFS), Orthogonal Frequency Division Multiplexing (OFDM), Orthogonal Time-Space Multiplexing (OTSM), or Block Single Carrier (SC).

According to one or more embodiments, the present disclosure relates to a successive interference cancellation (SIC) based multi-user uplink receiver. The SIC-based multi-user uplink receiver comprises a plurality of antennas, a plurality of analog-to-digital converter (ADC) devices, and at least one processor. The plurality of antennas is configured for receiving analog wireless signal from one or more transmitters corresponding to one or more users. The plurality of ADC devices is configured for converting analog wireless signals to corresponding digital signals. Further, the at least one processor is communicatively coupled with the one or more antennas and the plurality of ADC devices. The at least one processor is configured to receive signal of one or more multiple-access (MA) scheme waveforms from one or more users by the plurality of antennas of the multi-user uplink receiver at a base station or access point. The received signal in each antenna of the plurality of antenna relates to a composite signal from one or more users. The at least one processor is configured to determine one or more effective channel matrices corresponding to the plurality of antennas. Each of the one or more effective channel matrices for a corresponding antenna of the plurality of antennas is determined based on a type of the MA scheme waveforms from the one or more users in the corresponding antenna, and a length of received signal in the corresponding antenna from the one or more users.

Further, the at least one processor is configured to perform channel equalization for signal received in the corresponding antenna from one or more users by a channel equalization technique using each of the one or more effective channel matrices. Thereafter, the at least one processor is configured to combine, using an Equal Gain Combining (EGC) technique, channel equalized signal from the plurality of antennas to form a combined estimated effective transmission signal from the one or more users. Subsequently, the at least one processor is configured to detect Correctly Decoded Code Blocks (CCBs) and Wrongly Decoded Code Blocks (WCBs) of the received signal from each user of the one or more users. Further, the at least one processor is configured to perform the SIC on received signals from one or more users until all WCBs are converted to CCBs or a maximum number of threshold iterations are completed.

According to one or more embodiments, to detect CCBs and WCBs of each user, the at least one processor is configured to perform segregation on the EGC combined channel equalized signals to retrieve effective symbol vector transmitted by the corresponding user. Further, the at least one processor is configured to compute Log Likelihood Ratio (LLR) values from the retrieved symbol vector upon performing segregation on the EGC combined channel equalized signals. Thereby, the at least one processor is configured to decode each bit of the LLR values to retrieve code blocks transmitted by the corresponding user by a Low-Density Parity-Check (LDPC) decoder. Upon decoding each bit of the LLR values, at least one processor is configured to identify the CCBs and the WCBs based on the LDPC decoded values for each user. Thereby, the at least one processor is configured to regenerate the transmitted data symbol vector using the CCBs for each user for performing SIC in next iteration.

According to one or more embodiments, to regenerate the transmitted data symbol vector by using the CCBs in each of subsequent iterations, the at least one processor is configured to compute the regenerated symbol vector for each user to form a regenerated effective symbol vector. Further, the at least one processor is configured to generate a signal for cancelling interference in the corresponding received signal at each antenna by applying a corresponding effective channel matrix to the regenerated effective symbol vector in each subsequent iteration. The corresponding effective channel matrix relates to a channel effect during transmission of the wireless signal. Furthermore, the at least one processor is configured to cancel interference from data symbols of the received signal by subtracting the generated signal from the received signal. Thereby, the at least one processor is configured to update the corresponding channel equalization matrix based on the data symbols of the regenerated effective symbol vector upon cancelling the interference. Subsequently, the at least one processor is configured to perform channel equalization on interference free signal of each antenna for correcting code blocks in the received signal. The channel equalization is performed by the channel equalization technique using the updated corresponding channel equalization matrix.

Upon performing channel equalization, the at least one processor is configured to combine, using the EGC technique, channel equalized signal from each antenna of the one or more antennas to form interference free combined estimated effective transmission signal from the one or more users. Further, the at least one processor is configured to perform segregation on the EGC combined channel equalized signals to retrieve effective symbol vector transmitted by the corresponding user. Furthermore, the at least one processor is configured to compute LLR values from the retrieved symbol vector upon performing segregation on the EGC combined channel equalized signals. Moreover, the at least one processor is configured to decode selectively, by the LDPC decoder, each bit of the LLR values corresponding to the WCBs of the previous iteration to retrieve all code blocks transmitted by the corresponding user.

Upon decoding each bit of the LLR values corresponding to the WCBs of the previous iteration, the at least one processor is configured to identify the CCBs and the WCBs based on the LDPC decoded values for each user. Subsequently, the at least one processor is configured to regenerate data symbols in the transmitted data symbol vector by the one or more users from each bit of correctly decoded blocks in combination with previously detected CCBs.

According to one or more embodiments, to determine one or more effective channel matrices corresponding to one or more receive antennas, the at least one processor is further configured to generate an upsampling matrix, a cyclic forward permutation matrix, and a rectangular matrix with ones on the main diagonal axis and zeros elsewhere based on type of MA scheme and a number of symbols transmitted by the corresponding user. Further, the at least one processor is configured to determine one or more effective channel matrices based on the upsampling matrix, the cyclic forward permutation matrix, and the rectangular matrix.

According to one or more embodiments, size of the one or more effective channel matrices varies based on maximum number of symbols transmitted by a user among one or more users and total number of users transmitting signal to the plurality of antennas.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a schematic diagram of a 4-user scenario with multi-antenna reception at Base Station (BS) equipped with R antennas, in accordance with an embodiment of the present disclosure;

FIG. 2 illustrates a Successive Interference Cancellation (SIC)-based multi-user uplink receiver with multi-antenna reception, in accordance with an embodiment of the present disclosure;

FIG. 3 illustrates a flow chart of a method 300 of SIC in the multi-user uplink receiver, in accordance with an embodiment of the present disclosure;

FIG. 4 illustrates a detailed flow chart of method step 310 for detecting CCBs and WCBs of the received signal from each user of the one or more users, in accordance with an embodiment of the present disclosure;

FIG. 5 illustrates a detailed flow chart of method step 312 for performing the SIC on received signals in each of subsequent iterations, in accordance with an embodiment of the present disclosure; and

FIG. 6 illustrates a block error rate (BLER) achieved by the receiver of the present disclosure for three different multiple access (MA) schemes with OTFS: a partial loading-based multiple access scheme, Doppler-division multiple access (DoDM), and delay-division multiple access (deDM), in accordance with an embodiment of the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device, or process that comprises a list of components or steps does not include only those components or steps but may include other components or steps not expressly listed or inherent to such setup or device or process. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and which are shown by way of illustration-specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

According to an embodiment, scalars, matrices, and vectors are denoted by x, x, and X, respectively. [symbol] represents the set of all matrices of size M×N. x(i, j) denotes the element in the i^{th} row and j^{th} column of the matrix X. x[n] represents the nth element of the vector x. I_{N}, F_{N}, and W_{N} represent an Identity, normalized discrete Fourier transform (DFT), and normalized Walsh-Hadamard matrices of size N×N, respectively. A vector of length N with all zeros is represented by ON, and one with all ones is represented by I_{N}. The juxtaposition of variables such as xy denotes multiplication between x and y. ( )^{T} and ( )^{H} signify the transpose and conjugate transpose operations, respectively. vec (X) vectorizes X. If x∈ [symbol] , diag (x) is an N× N diagonal matrix.

According to an embodiment, considering a multi-user uplink scenario, each u^{th} user, for u=1, 2, . . . , U, sends Kᵤ data quadrature amplitude modulation (QAM) or phase shift keying (PSK) symbols of order M to a base station (BS). For simplicity, it is referred to data symbols as QAM modulated symbols. The total number of QAM symbols sent by all users will not exceed N, i.e., as shown in Equation (1):

$${K}_{MU} = {\sum }_{u = 1}^{U} {K}_{u} \leq N . \qquad ( 1 )$$

The vector dᵤ of Kᵤ data symbols is converted to another vector \tilde{x}ᵤ of length N for transmission as shown in Equation (2):

$${\tilde{x}}_{u} = {J}_{u} {d}_{u} , \qquad ( 2 )$$

where Jᵤ is a semi-orthogonal matrix of size N×Kᵤ that satisfies as shown in Equation (3):

$${J}_{u}^{T} {J}_{u} = {I}_{Ku} \qquad ( 3 )$$

The \tilde{x}ᵤ may undergo waveform modulation for transmission using waveforms like orthogonal time frequency space (OTFS), orthogonal frequency division multiplexing (OFDM), orthogonal time sequency multiplexing (OTSM), or block-based single carrier (block SC). The waveform modulation can be expressed for these four waveforms as shown in Equation (4):

$${\tilde{s}}_{u} = ( P ⊗ Q ) {\tilde{x}}_{u} , \qquad ( 4 )$$

where the matrices P and Q are listed for the four waveforms in Table 1, shown below, with values for M^{l} and N^{l} such that the product M^{l}N^{l}=N. A single cyclic prefix (CP) may be added to \tilde{s}ᵤ, then transmitted to the BS.

TABLE 1

| Waveform | OTFS | OFDM | OTSM | Block SC |
|---|---|---|---|---|
| P | ${F}_{{N}^{′}}^{H}$ | I_{N′} | W_{N′} | I_{N′} |
| Q | I_{M′} | ${F}_{{M}^{′}}^{H}$ | I_{M′} | I_{M′} |

At the BS, a composite signal for multi-user transmission is received at each r^{th} receive antenna, for r=1, 2, . . . , R. The BS receives wireless signal upon removing cyclic prefix from the received wireless signals for further processing. The received signal after discarding CP, the yᵣ is applied to waveform demodulation as shown in Equation (5). Such equation converts the signal in symbol domain instead of time domain. Symbol domain refers to abstraction of the communication signal at symbol level, where focus is on discrete symbols (data points) that represent the information being transmitted. Particularly, symbol domain depends on received waveform.

$${y}_{r} = ( {P}^{H} ⊗ {Q}^{H} ) {y}_{r} . \qquad ( 5 )$$

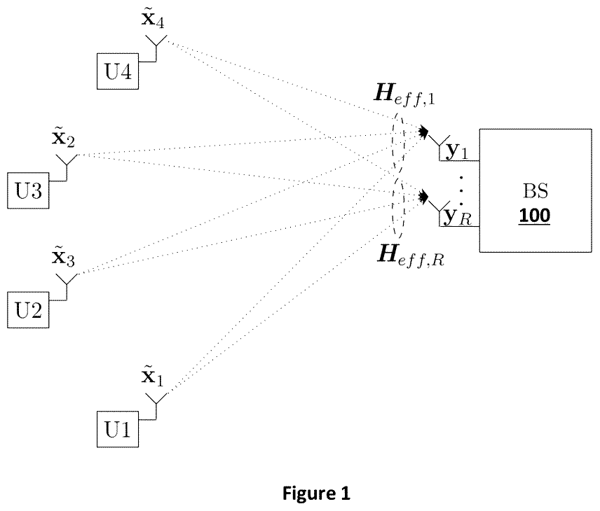

FIG. 1 illustrates a schematic diagram of a 4-user scenario with multi-antenna reception at Base Station (BS) equipped with R antennas, in accordance with an embodiment of the present disclosure.

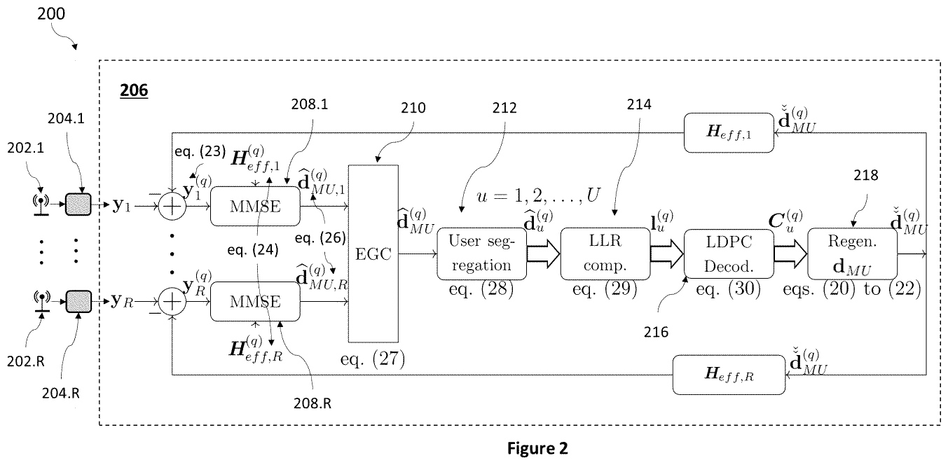

As shown in FIG. 1, the BS 100 or access point comprises a multi-user uplink receiver as shown in FIG. 2 in subsequent paragraphs of the present invention. A plurality of antennas of the multi-user uplink receiver receives signal of one or more multiple-access (MA) scheme waveforms from one or more users. The received signal in each antenna of the plurality of antennas relates to a composite signal from one or more users.

For sake of brevity, blocks for waveform modulation, demodulation, and CP inclusion/exclusion are omitted in the figure. Expressing yᵣ with individual users' symbol domain transmissions and channel impulse responses as shown in Equation (6):

$${y}_{r} = {\sum }_{u = 1}^{U} {H}_{u , r} {\tilde{x}}_{u} + w , \qquad ( 6 )$$

where H_{u,r}∈ [symbol] is the channel convolution matrix between the u^{th} user and r^{th} receive antenna of the BS with respect to \tilde{x}ᵤ.

Now, by using Equation (2), Equation (6) is re-written as:

$${y}_{r} = {\sum }_{u = 1}^{U} {H}_{u , r} {J}_{u} {d}_{u} + w . \qquad ( 7 )$$

According to one or more embodiments, the multi-user uplink receiver of the BS 100 determines one or more effective channel matrices corresponding to the plurality of antennas. Each of the one or more effective channel matrices for a corresponding antenna of the plurality of antennas is determined based on a type of the MA scheme waveforms from the one or more users in the corresponding antenna, and a length of the received signal in the corresponding antenna from the one or more users.

Particularly, for channel equalization and retrieval of individual users' transmitted data symbols from yᵣ, the effective channel matrix is formed for this multi-user scenario using an upsampling matrix, a cyclic forward permutation matrix, and a rectangular matrix with ones on the main diagonal and zeros elsewhere, as given in Equations (8), (9), and (10) respectively.

$${U}_{{K}_{u} , U} = {[ \begin{matrix}1 & {0}_{U} & … & {0}_{U} \\ {0}_{U - 1} & 1 & & ⋮ \\ {0}_{U} & {0}_{U - 1} & & \\ ⋮ & {0}_{U} & & {0}_{U} \\ & ⋮ & & 1 \\ {0}_{U} & {0}_{U} & & {0}_{U - 1}\end{matrix} ]}_{{UK}_{u} \times {K}_{u}} , \qquad ( 8 )$$

$${\prod }_{{UK}_{max}} = {[ \begin{matrix}{0}_{{UK}_{max} - 1}^{T} & 1 \\ {I}_{{UK}_{max} - 1} & {0}_{{UK}_{max} - 1}\end{matrix} ]}_{{UK}_{max} \times {UK}_{max}} , \qquad ( 9 )$$

$$and$$

$${ϒ}_{u} = [ \begin{matrix}{I}_{{UK}_{u}} \\ {0}_{U ( {K}_{max} - {K}_{u} ) \times {UK}_{u}}\end{matrix} ] , \qquad ( 10 )$$

$$where$$

$${K}_{max} = max ( {K}_{1} , {K}_{2} , … , {K}_{U} ) , \qquad ( 11 )$$

With max ( ) being the operator to find the maximum of the given elements as its arguments. The matrix U_{K}_{ᵤ}_{,U} upsamples a vector of length Kᵤ by inserting zeros with an upsampling factor U through multiplication. The corresponding downsampling can be performed with its transpose as Equation (12):

$${U}_{{K}_{u} , U}^{T} {U}_{{K}_{u} , U} = {I}_{{K}_{u}} . \qquad ( 12 )$$

Further, using Equations 2 and 12, Equation 6 may be rewritten as Π_{UKmax} and Y′ᵤ matrices as shown in Equation (13).

$${y}_{r} = {\sum }_{u = 1}^{U} {H}_{u , r} {J}_{u} {U}_{{K}_{u} , U}^{T} {ϒ}_{u}^{T} {\prod }_{{UK}_{max}}^{- u + 1} {\prod }_{{UK}_{max}}^{u - 1} {ϒ}_{u} {U}_{{K}_{u} , U} {d}_{u} + w . \qquad ( 13 )$$

For any non-zero integer z<U, it can be shown as per Equation (14):

$${U}_{{K}_{u} , U}^{T} {ϒ}_{u}^{T} {\prod }_{{UK}_{max}}^{z} {ϒ}_{u} {U}_{{K}_{u} , U} = {0}_{{K}_{u} \times {K}_{u}} . \qquad ( 14 )$$

Further, using Equation (14), rewriting Equation (13) as mentioned below in Equation (15):

$${y}_{r} = {\underbrace{{\sum }_{u = 1}^{U} {H}_{u , r} {J}_{u} {U}_{{K}_{u} , U}^{T} {ϒ}_{u}^{T} {\prod }_{{UK}_{max}}^{- u + 1}}}_{{H}_{eff , r}} {\underbrace{{\sum }_{{u}^{′} = 1}^{U} {\prod }_{{UK}_{{u}^{′}}}^{{u}^{′} - 1} {ϒ}_{{u}^{′}} {U}_{{K}_{{u}^{′}} , U} {d}_{{u}^{′}}}}_{{d}_{MU}} + w \qquad ( 15 )$$

### Defining

$${H}_{eff , r} {=}^{Δ} {\sum }_{u = 1}^{U} {H}_{u} {J}_{u} {U}_{{K}_{u} , U}^{T} {ϒ}_{u}^{T} {\prod }_{{UK}_{max}}^{- u + 1} , \qquad ( 16 )$$

$$and$$

$${d}_{MU} {=}^{Δ} {\sum }_{u = 1}^{U} {\prod }_{{UK}_{u}}^{u - 1} {ϒ}_{u} {U}_{{K}_{u} , U} {d}_{u} . \qquad ( 17 )$$

Using Equation (15), Equation (16), and Equation (17), the received signal at each r^{th} receive branch of the BS for r=1, 2, . . . , R, can be expressed as shown in Equation (18):

$${y}_{r} = {H}_{eff , r} {d}_{MU} + w , \qquad ( 18 )$$

which is similar to the received signal expression for single user scenarios with single antenna reception. The size of the effective channel matrix H_{eff,r} for multi-user scenarios in Equation (16) is N×UKₘₐₓ. As per Equation (16), size of Hᵤ is N×N, size of Jᵤ is N×Kᵤ, size of

$${U}_{Ku , U}^{T}$$

is Kᵤ×UKᵤ, size of

$${ϒ}_{u}^{T}$$

is Kᵤ×UKₘₐₓ, and size of

$${\prod }_{{UK}_{max}}^{- u + 1}$$

is UKₘₐₓ×UKₘₐₓ. Therefore, from size of each parameter of Equation (16), it is proved that size of the effective channel matrix H_{eff,r} is N×UKₘₐₓ. Thus, instead of fixed sized effective channel matrix, N×N, as disclosed prior art documents, size of the effective channel matrix H_{eff,r} is N×UKₘₐₓ as disclosed in the present disclosure. Therefore, the size of the effective channel matrix is variable based on maximum number of symbols transmitted by the user among one or more users, and the total number of users transmitting signal to the plurality of antennas.

FIG. 2 illustrates SIC-based multi-user uplink receiver with multi-antenna reception, in accordance with an embodiment of the present disclosure. The SIC-based multi-user uplink receiver with multi-antenna reception is also alternatively recited as “SIC-based multi-user uplink receiver” throughout the disclosure without deviating scope of the present disclosure.

As shown in FIG. 2, the SIC-based multi-user uplink receiver 200 comprises a plurality of antennas 202.1, . . . , 202.R (hereinafter may be combinedly recited as “the antenna 202”), a plurality of analog-to-digital converter (ADC) devices 204.1, . . . , 204.R (hereinafter may be combinedly recited as “the ADC device 204”), and at least one processor 206 (hereinafter may be combinedly recited as “the processor 206”). The plurality of antennas 202.1, . . . , 202.R is configured for receiving analog wireless signal from one or more transmitters corresponding to one or more users. Further, the plurality of ADC devices 204.1, . . . , 204.R is configured for converting analog wireless signals to corresponding digital signals. The at least one processor 206 is communicatively coupled with the antenna 202 and the ADC device 204.

According to an embodiment, the FEC based SIC receiver iteratively detects each u^{th} user's transmitted data symbols dᵤ over multiple iterations from the R received signals from R antennas. In each q^{th} iteration, for q=1, 2, . . . . Q, the FEC code blocks (CBs) that are correctly decoded by the LDPC decoder up to the previous iteration are used to cancel the interference in the received signals. This helps detect the CBs that were incorrectly decoded in the previous iteration. The LDPC decoder output in bits from previous iteration is considered to be in a matrix

$${C}_{u}^{( q - 1 )} = [ {c}_{u , 1}^{( q - 1 )} , {c}_{u , 1}^{( q - 1 )} , ... , {c}_{u , 1}^{( q - 1 )} ]$$

of size Cₗ×Lᵤ, where Lᵤ is the number of CBs transmitted by the u^{th} user and Cₗ is the CB length. The indices of the columns of

$${C}_{u}^{( q - 1 )}$$

containing correctly decoded CBs (CCBs) are noted in a vector

$${a}_{u}^{( q - 1 )}$$

as shown in Equation (19):

$${a}_{u}^{( q - 1 )} [ η ] = \{ \begin{matrix}1 & if {c}_{u , η}^{( q - 1 )} is a CCB \\ 0 & otherwise\end{matrix} , \qquad ( 19 )$$

where η=0, 1, . . . , Lu−1. A QAM symbol matrix

$${U}_{u}^{( q )} = [ {u}_{u , 0}^{( q )} , {u}_{u , 1}^{( q )} , ... , {u}_{u , {L}_{u} - 1}^{( q )} ]$$

f size

$$\frac{{C}_{l}}{{log}_{2}^{M}} \times {L}_{u}$$

for each user is obtained by mapping the bits in

$${c}_{u , 1}^{( q - 1 )}$$

to QAM symbols as shown in Equation (20):

$${u}_{u , η}^{( q )} = \{ \begin{matrix}𝔐 ( {c}_{u , η}^{( q - 1 )} ) & if {a}_{u}^{( q - 1 )} [ η ] = 1 \\ {0}_{\frac{{c}_{l}}{{log}_{2} ℳ}} & otherwise\end{matrix} , \qquad ( 20 )$$

where [symbol] (.) is an operator for QAM modulation that produces a QAM symbol vector for the input bits. Using Equation (20), regenerating the symbol vector dᵤ that was transmitted by the u^{th} user as equation (21):

$${\check{\check{d}}}_{u}^{( q )} = vec ( {U}_{u}^{( q )} ) \qquad ( 21 )$$

The

$${\check{\check{d}}}_{u}^{( q )}$$

comprises QAM symbols positioned in alignment with the CCBs and are expected to be same as the transmitted symbols. Zero symbols are located in the positions corresponding to the wrongly decoded CBs. Using (17) and (21), the regenerated d_{MU} is expressed as per equation (22):

$${\check{\check{d}}}_{MU}^{( q )} = {\sum }_{u = 1}^{U} {\prod }_{{UK}_{max}}^{u - 1} {Υ}_{u} {U}_{Ku , U} {\check{\check{d}}}_{u}^{( q )} \qquad ( 22 )$$

Now, canceling the interference in the received signal at each r^{th} receive antenna as Equation (23):

$${y}_{r}^{( q )} = {y}_{r} - {H}_{eff , r} {\check{\check{d}}}_{MU}^{( q )} \qquad ( 23 )$$

where

$${\check{\check{d}}}_{MU}^{( q )}$$

is set to zero vector 0_{UK}_{ₘₐₓ} for q=1 (in the first iteration). The interference-free signal

$${y}_{r}^{( q )}$$

at each r^{th} receive branch is MMSE equalized using an updated channel matrix

$${H}_{eff , r}^{( q )} .$$

This updated channel matrix is also alternatively called a channel equalization matrix throughout the disclosure without deviating the scope of the present invention. This is obtained by nullifying those column vectors of H_{eff,r} in Equation (16), whose indices of elements in

$${\check{\check{d}}}_{MU}^{( q )}$$

are non-zeros as shown in Equation (24):

$${H}_{eff , r}^{( q )} = {H}_{eff , r} diag ( {b}^{( q )} ) \qquad ( 24 )$$

where b^{(q)}∈ [symbol] is a vector with elements b^{(q)}[m], for m=0, 1, . . . , UKₘₐₓ−1, expressed as in Equation (25):

$${b}^{( q )} [ m ] = \{ \begin{matrix}1 & if {\check{\check{d}}}_{MU}^{( q )} [ m ] = 0 \\ 0 & otherwise\end{matrix} . \qquad ( 25 )$$

Further, the SIC-based multi-user uplink receiver 200 performs channel equalization by a channel equalization technique using each of the one or more effective channel matrices H_{eff,r} for signal received in the corresponding antenna from one or more users. The channel equalization technique may correspond to any one of Minimum Mean Squared Error (MMSE) Equalization, Zero Forcing (ZF), etc. The channel equalization is performed to compensate distortion introduced in channel of transmitted signals that are being transmitted by the one or more users. In the present disclosure, the channel equalization technique is considered as MMSE equalization.

Performing MMSE equalization 208.1 . . . 208.R (hereinafter may combinedly referred to as “MMSE equalization 208”) on each

$${y}_{r}^{( q )}$$

using

$${H}_{eff , r}^{( q )}$$

as shown in Equation (26):

$${\hat{d}}_{MU , r}^{( q )} = {( {H}_{eff , r}^{( q ) H} {H}_{eff , r}^{( q )} + {σ}^{2} {I}_{{UK}_{max}} )}^{- 1} {H}_{eff , r}^{( q ) H} {y}_{r}^{( q )} . \qquad ( 26 )$$

Thereby, the SIC-based multi-user uplink receiver 200 combines 212 channel equalized signal from the plurality of antennas to form a combined estimated effective transmission signal from the one or more users. The MMSE output from all receive branches is processed using Equal Gain Combining (EGC) to obtain an estimate for d_{MU} as shown in Equation (27):

$${\hat{d}}_{MU}^{( q )} = \frac{1}{R} {\sum }_{r = 1}^{R} {\hat{d}}_{MU , r}^{( q )} \qquad ( 27 )$$

Further, the SIC-based multi-user uplink receiver 200 performs segregation 212 on the EGC combined channel equalized signals to retrieve effective symbol vector transmitted by the corresponding user. Using the orthogonality condition given in (14), estimate for dᵤ can be obtained as shown in Equation (28):

$${\hat{d}}_{u}^{( q )} = {U}_{{K}_{u ,} U}^{T} {γ}_{u}^{T} {\prod }_{{UK}_{maz}}^{- u + 1} {\hat{d}}_{MU}^{( q )} \qquad ( 28 )$$

Further, the SIC-based multi-user uplink receiver 200 computes Log Likelihood Ratio (LLR) values 214 from the retrieved symbol vector upon performing segregation on the EGC combined channel equalized signals. The LLR values are computed for QAM symbol estimates in each

$${\hat{d}}_{u}^{( q )}$$

as shown in Equation (29):

$${I}_{u , k , υ}^{( q )} = \frac{1}{{σ}^{2}} ( {min}_{s ∈ {S}_{υ}^{0}} {‖ {\hat{d}}_{u}^{( q )} [ k ] - s ‖}^{2} - {min}_{s ∈ {S}_{υ}^{1}} {‖ {\hat{d}}_{u}^{( q )} [ k ] - s ‖}^{2} ) \qquad ( 29 )$$

where

$${I}_{u , k , υ}^{( q )}$$

is the LLR value for the v^{th} bit of log₂ M bits for QAM symbol estimate

$${\hat{d}}_{u}^{( q )} [ k ] .$$

The sets

$${S}_{υ}^{0} and {S}_{υ}^{1}$$

represent the constellation symbols with v^{th} bit being 1 and 0, respectively. The output LLR values

$${I}_{u}^{( q )}$$

of each u^{th} user is reshaped into a matrix, \tilde{C}ᵤ=[\tilde{c}_{u,1}, \tilde{c}_{u,2}, . . . , \tilde{c}_{u,η}, . . . , \tilde{c}_{u,L}_{ᵤ}] where each η^{th} column vector \tilde{c}_{u,η}∈ [symbol] corresponds to the LLR values of the η^{th} code block transmitted by the u^{th} user.

Now, the SIC-based multi-user uplink receiver 200 decodes 216 each bit of the LLR values by a Low-Density Parity-Check (LDPC) decoder to retrieve code blocks transmitted by the corresponding user. So, the LLR values in \tilde{C}ᵤ applied to the LDPC decoder, which selectively decodes those CBs, which were wrongly decoded in the previous iteration. The LDPC decoder output is stored in

$${C}_{u}^{( q )} = [ {c}_{u , 1}^{( q )} , {c}_{u , 2}^{( q )} , … , {c}_{u , {L}_{u}}^{( q )} ]$$

for each u^{th} user individually as shown in Equation (30):

$${c}_{u , η}^{( q )} = \{ \begin{matrix}LDPCdecode ( {\tilde{c}}_{u , η} ) & if {a}_{u}^{( q - 1 )} [ η ] = 0 \\ {c}_{u , η}^{( q - 1 )} & otherwise\end{matrix} \qquad ( 30 )$$

Upon decoding each bit of the LLR values, the SIC-based multi-user uplink receiver 200 identifies the CCBs and the WCBs based on the LDPC decoded values for each user. Thereby, the SIC-based multi-user uplink receiver 200 regenerates 218 the transmitted data symbol vector using the CCBs for each user for performing SIC in next iteration and each of subsequent iterations. Particularly, from the LDPC decoding output

$${C}_{u}^{( q )} ,$$

the correctly decoded CBs would be determined accordingly the vector

$${a}_{u}^{( q - 1 )}$$

in Equation (19) is updated to

$${a}_{u}^{( q )} ,$$

which will be used in the subsequent iteration.

According to one or more embodiments, the SIC-based multi-user uplink receiver 200 performs the SIC on received signals in each of subsequent iterations. Particularly, the SIC-based multi-user uplink receiver 200 computes the regenerated data symbol vector for each user (as shown in Equation (21) of the present disclosure) to form a regenerated effective symbol vector (as shown in Equation (22) of the present disclosure). Thereby, the SIC-based multi-user uplink receiver 200 generates a signal for cancelling interference in the corresponding received signal at each antenna by applying a corresponding effective channel matrix H_{eff,r} among the one or more effective channel matrices to the regenerated effective symbol vector in each subsequent iteration. The corresponding effective channel matrix H_{eff,r} relates to a channel effect during transmission of the wireless signal. Thereby, the SIC-based multi-user uplink receiver 200 cancels (as shown in equation 23 of the present disclosure) interference from data symbols of the received signal by subtracting the generated signal from the received signal. Further, the SIC-based multi-user uplink receiver 200 updates a corresponding channel equalization matrix

$${H}_{eff , r}^{( q )}$$

based on the multi-user uplink corresponding effective channel matrix H_{eff,r} and the data symbols

$${y}_{R}^{( q )}$$

of the regenerated effective symbol vector upon cancelling the interference.

The SIC-based multi-user uplink receiver 200 performs channel equalization 208 on interference free signal of each antenna for correcting code blocks in the received signal. The channel equalization 208 is performed by the channel equalization technique using the updated corresponding channel equalization matrix. Thereby, the SIC-based multi-user uplink receiver 200 combines channel equalized signal 210 using the EGC technique from each antenna of the one or more antennas to form interference free combined estimated effective transmission signal from the one or more users. Subsequently, the SIC-based multi-user uplink receiver 200 performs segregation 212 on the EGC combined channel equalized signals to retrieve effective symbol vector transmitted by the corresponding user. Moreover, the SIC-based multi-user uplink receiver 200 computes LLR values 214 from the retrieved symbol vector upon performing segregation on the EGC combined channel equalized signals. Further, the SIC-based multi-user uplink receiver 200 selectively decodes 216 by the LDPC decoder each bit of the LLR values corresponding to the WCBs of the previous iteration to retrieve all code blocks transmitted by the corresponding user. Upon decoding each bit of the LLR values corresponding to the WCBs of the previous iteration, the SIC-based multi-user uplink receiver 200 identifies the CCBs and the WCBs based on the LDPC decoded values for each user. Further, the SIC-based multi-user uplink receiver 200 regenerates 218 data symbols from the transmitted data symbol vector by the one or more users from each bit of correctly decoded blocks in combination with previously detected CCBs. The data symbol vector comprises data symbols regenerated from CCBs and zero symbols for corresponding positions of WCBs. Such data symbol vector is used for computation in next iteration.

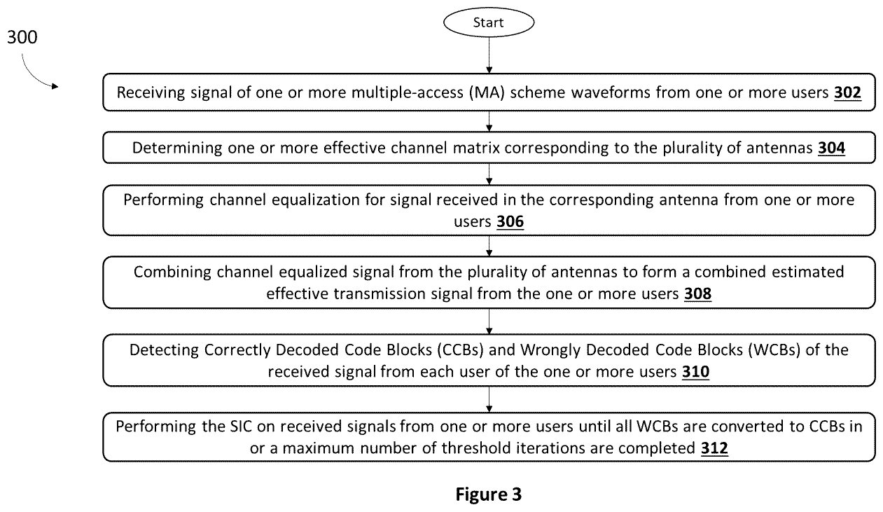

FIG. 3 illustrates a flow chart of a method 300 of SIC in the multi-user uplink receiver, in accordance with an embodiment of the present disclosure. The method 300 comprises cancelling the interference in the received signal by the FEC-based SIC receiver 200. As depicted in FIG. 3, the method 300 includes a series of steps 302 through 312 for interference cancellation in the signal. The details of the method 300 have been explained below in forthcoming paragraphs. The order in which the method steps are described below is not intended to be construed as a limitation, and any number of the described method steps can be combined in any appropriate order to execute the method or an alternative method. The method 300 begins from a start block and starts execution of operations at step 302, as shown in FIG. 3.

At step 302, in a first iteration, the method 300 comprises receiving signal (y₁, . . . , y_{R}) by the plurality of antennas (202.1, . . . , 202.R) of the multi-user uplink receiver 200 at the base station 100 or access point. The received signal is of one or more MA scheme waveforms from one or more users (U₁, . . . , U_{U}). The received signal in each antenna of the plurality of antennas (202.1, . . . , 202.R) relates to the composite signal from one or more users. The flow of the method 300 now proceeds to step 304.

At step 304, in the first iteration, the method 300 comprises determining one or more effective channel matrices H_{eff,r} corresponding to the plurality of antennas (202.1, . . . , 202.R). Each of the one or more effective channel matrices H_{eff,r} for the corresponding antenna of the plurality of antennas (202.1, . . . , 202.R) is determined based on the type of the MA scheme waveforms from the one or more users in the corresponding antenna, and the length of the received signal in the corresponding antenna from the one or more users. Thus, size of the one or more effective channel matrices is variable, that is, N×UKₘₐₓ as demonstrated by Equation (16) of the present disclosure. As size of the one or more effective channel matrices is variable, therefore, the present disclosure provides time and complexity improvement over the prior art disclosures. The flow of the method 300 now proceeds to step 306.

At step 306, in the first iteration, the method 300 comprises performing channel equalization by the channel equalization technique using each of the one or more effective channel matrices for signal received in the corresponding antenna from one or more users. In the present disclosure, the channel equalization technique relates to MMSE. By applying MMSE, the method generates channel equalized signal

$${\hat{d}}_{MU , r}^{( q )}$$

as shown in Equation (26) of the present disclosure. The flow of the method 300 now proceeds to step 308.

At step 308, in the first iteration, the method 300 comprises combining channel equalized signal from the plurality of antenna using the EGC technique to form the combined estimated effective transmission signal from the one or more users. The method combines channel equalized signal

$${\hat{d}}_{MU , r}^{( q )}$$

to form the combined estimated effective transmission signal

$${\hat{d}}_{MU}^{( q )}$$

as shown in Equation (27) of the present disclosure. The flow of the method 300 now proceeds to step 310.

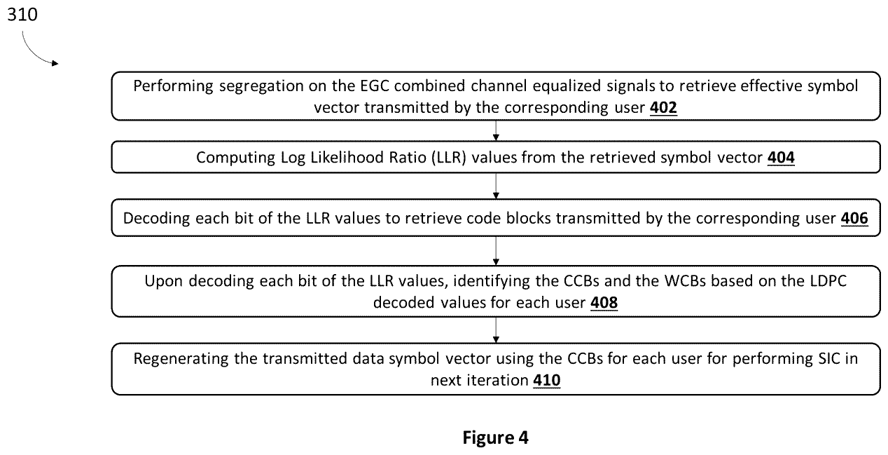

At step 310, in the first iteration, the method 300 comprises detecting Correctly Decoded Code Blocks (CCBs) and Wrongly Decoded Code Blocks (WCBs) of the received signal from each user of the one or more. Detailed steps of detection of the CCBs and WCBs from the combined estimated effective transmission signal is disclosed in FIG. 4 of the present disclosure. The flow of the method 300 now proceeds to step 312.

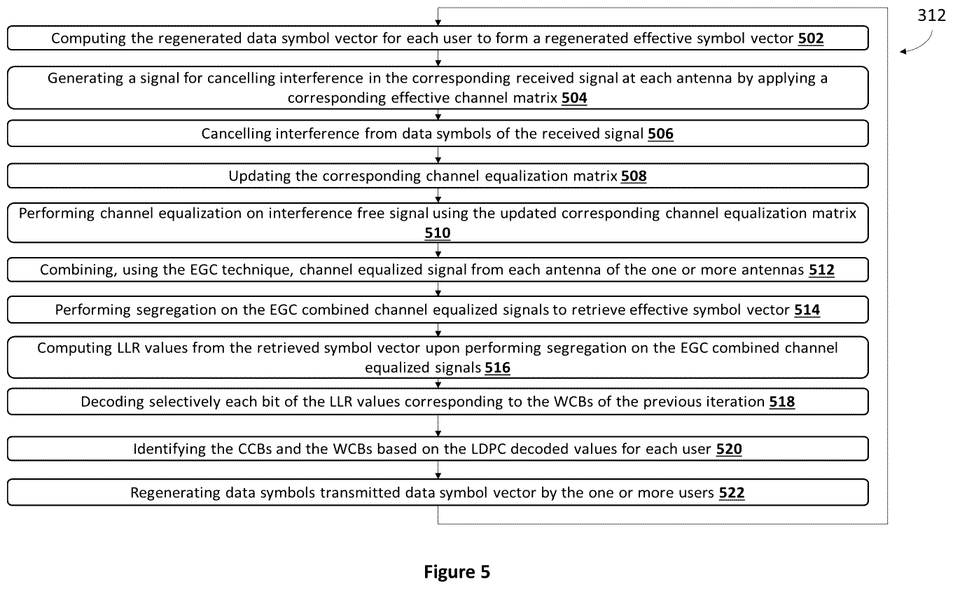

At step 312, in the first iteration, the method 300 comprises performing the SIC on received signals from one or more users until all WCBs are converted to CCBs or a maximum number of threshold iterations are completed. Once all WCBs are converted to CCBs, then all interference encountered during transmission of signal was nullified and SIC-based multi-user uplink receiver 200 is able to find out original signal transmitted by multiple users. Alternatively, the maximum number of threshold iterations are set to avoid any continuous execution loop during determination of CCBs from the WCBs. Further, details of subsequent iterations are clearly disclosed in FIG. 5 of the present disclosure.

While the above-discussed steps in FIG. 3 are shown and described in a particular sequence, the steps may occur in variations to the sequence in accordance with various embodiments. Further, a detailed description related to the various steps of FIG. 3 is already covered in the description related to FIGS. 1-2 and is omitted herein for the sake of brevity.

FIG. 4 illustrates a detailed flow chart of a method step 310 for detecting CCBs and WCBs of the received signal from each user of the one or more users, in accordance with an embodiment of the present disclosure. As depicted in FIG. 4, the method 310 includes a series of steps 402 through 410 for identifying the one or more CCBs and the one or more WCBs. The method step 310 for identifying the one or more CCBs and the one or more WCBs is performed for the initial iteration. The method 310 begins execution of operations at step 402, as shown in FIG. 4.

At step 402, the method 310 comprises performing segregation on the EGC combined channel equalized signals to retrieve effective symbol vector transmitted by the corresponding user. Thus, the method 310 comprises performing segregation of the combined estimated effective transmission signal

$${\hat{d}}_{MU}^{( q )}$$

to retrieve the estimated dᵤ as shown in Equation (28) of the present disclosure. The flow of the method 310 now proceeds to step 404.

At step 404, the method 310 comprises computing LLR values from the retrieved symbol vector upon performing segregation on the EGC combined channel equalized signals. The LLR values are computed for the QAM symbol estimates in each

$${\hat{d}}_{u}^{( q )}$$

as shown in Equation (29). The flow of the method 310 now proceeds to step 406.

At step 406, the method 310 comprises decoding each bit of the LLR values by the LDPC decoder to retrieve code blocks transmitted by the corresponding user. The LDPC decoder output is stored in

$${C}_{u}^{( q )}$$

as shown in Equation (30) of the present disclosure. The flow of the method 310 now proceeds to step 408.

At step 408, upon decoding each bit of the LLR values, the method 310 comprises identifying the CCBs and the WCBs based on the LDPC decoded values for each user. From the LDPC decoding output

$${C}_{u}^{( q )}$$

the correctly decoded CBS would be determined accordingly the vector

$${a}_{u}^{( q - 1 )}$$

in Equation (19) is updated to

$${a}_{u}^{( q )} ,$$

which will be used in the subsequent iteration, that is in second iteration and subsequent iterations. The flow of the method 310 now proceeds to step 410.

At step 410, the method 310 comprises regenerating the transmitted data symbol vector using the CCBs for each user for performing SIC in next iteration. Particularly, the method comprises regenerating data symbol vector for each user (as shown in Equation (21) of the present disclosure) that is used in next iteration, i.e., in each of second and subsequent iterations.

While the above-discussed steps in FIG. 4 are shown and described in a particular sequence, the steps may occur in variations to the sequence in accordance with various embodiments. Further, a detailed description related to the various steps of FIG. 4 is already covered in the description related to FIGS. 1-2 and is omitted herein for the sake of brevity.

FIG. 5 illustrates a detailed flow chart of a method step 312 for performing the SIC on received signals in each of subsequent iterations, in accordance with an embodiment of the present disclosure. As depicted in FIG. 5, the method 312 includes a series of steps 502 through 520 for performing the SIC. The method step 312 for performing the SIC is performed in second iteration and each subsequent iterations. The method 312 begins execution of operations at step 502, as shown in FIG. 5.

At step 502, in second iteration and each subsequent iterations, the method 312 comprises computing the regenerated data symbol vector for each user to form the regenerated effective symbol vector. Particularly, regenerated data symbol vector for each user (as shown in Equation (21) of the present disclosure) is used to form the regenerated effective symbol vector (as shown in Equation (22) of the present disclosure). The regenerated effective symbol vector is generated for using in next iteration. Such regenerated effective symbol vector is primary used for updating corresponding effective channel matrix and cancelling interference in next iteration. The flow of the method 312 now proceeds to step 504.

At step 504, in second iteration and each subsequent iterations, the method 312 comprises generating the signal for cancelling interference in the corresponding received signal at each antenna by applying the corresponding effective channel matrix among the one or more effective channel matrices to the regenerated effective symbol vector. The corresponding effective channel matrix relates to the channel effect during transmission of the wireless signal. The generated signal is expressed as

$${H}_{eff , r} {{\hat{d}}^{⌣}}_{MU}^{( q )}$$

in Equation (23) of the present disclosure. The flow of the method 312 now proceeds to step 506.

At step 506, in second iteration and each subsequent iterations, the method 312 comprises cancelling interference from data symbols of the received signal by subtracting the generated signal from the received signal. Canceling the interference in the received signal at each r^{th} receive antenna is shown in Equation (23) of the present disclosure. The flow of the method 312 now proceeds to step 508.

At step 508, in second iteration and each subsequent iterations, the method 312 comprises updating the corresponding channel equalization matrix based on the corresponding effective channel matrix and the data symbols of the regenerated effective symbol vector upon cancelling the interference. The corresponding channel equalization matrix is updated by nullifying columns of the effective channel matrix whose indices match with reconstructed QAM symbols in the regenerated effective symbol vector. The corresponding channel equalization matrix is obtained by nullifying those column vectors of H_{eff,r} in Equation (16), whose indices of elements in

$${{{d}^{⌣}}^{⌣}}_{MU}^{( q )}$$

are non-zeros as shown in Equation (24) of the present disclosure. The flow of the method 312 now proceeds to step 510.

At step 510, in second iteration and each subsequent iterations, the method 312 comprises performing channel equalization on interference free signal of each antenna for correcting code blocks in the received signal. The channel equalization is performed by the channel equalization technique, i.e., MMSE equalization, using the updated corresponding channel equalization matrix. Upon performing MMSE equalization on interference free signal,

$${\hat{d}}_{MU , r}^{( q )}$$

is generated as shown in Equation (26) of the present disclosure. The flow of the method 312 now proceeds to step 512.

At step 512, in second iteration and each subsequent iterations, the method 312 comprises combining channel equalized signal from each antenna of the one or more antennas to form interference free combined estimated effective transmission signal from the one or more users. The combining channel equalized signal is performed by using the EGC technique. Such EGC processing is disclosed in Equation (27) of the present disclosure. The flow of the method 312 now proceeds to step 514.

At step 514, in second iteration and each subsequent iterations, the method 312 comprises performing segregation on the EGC combined channel equalized signals to retrieve effective symbol vector transmitted by the corresponding user. The segregation is performed to retrieve effective symbol vector transmitted by the corresponding user. Such segregation is shown in Equation (28) of the present disclosure. The flow of the method 312 now proceeds to step 516.

At step 516, in second iteration and each subsequent iterations, the method 312 comprises computing LLR values from the retrieved symbol vector upon performing segregation on the EGC combined channel equalized signals. The LLR values are computed as shown in Equation (29) of the present disclosure. The flow of the method 312 now proceeds to step 518.

At step 518, in second iteration and each subsequent iterations, the method 312 comprises decoding selectively each bit of the LLR values corresponding to the WCBs of the previous iteration to retrieve all code blocks transmitted by the corresponding user. The selective decoding of each bit of LLR values corresponding to the WCBs are performed by the LDPC decoder. Such selective decoding is shown in Equation (30) of the present disclosure. The flow of the method 312 now proceeds to step 520.

At step 520, in second iteration and each subsequent iterations, upon decoding each bit of the LLR values corresponding to the WCBs of the previous iteration, the method 312 comprises identifying the CCBs and the WCBs based on the LDPC decoded values for each user. Therefore, from the LDPC decoding output

$${C}_{u}^{( q )} ,$$

the correctly decoded CBs would be determined accordingly the vector

$${a}_{u}^{( q - 1 )}$$

in Equation (19) is updated to

$${a}_{u}^{( q )} ,$$

which will be used in the subsequent iteration. The flow of the method 312 now proceeds to step 522.

At step 520, in second iteration and each subsequent iterations, the method 312 comprises regenerating data symbols from the transmitted data symbol vector by the one or more users from each bit of correctly decoded blocks in combination with previously detected CCBs. Such regenerated data symbols are again feed into step 502 of next iteration until all WCBs are converted to CCBs or the maximum number of threshold iterations are completed.

While the above-discussed steps in FIG. 5 are shown and described in a particular sequence, the steps may occur in variations to the sequence in accordance with various embodiments. Further, a detailed description related to the various steps of FIG. 5 is already covered in the description related to FIGS. 1-2 and is omitted herein for the sake of brevity.

According to an embodiment, the method steps of FIGS. 3, 4, and 5 and other operations disclosed herein are performed by the at least one processor 206 of the SIC-based multi-user uplink receiver 200.

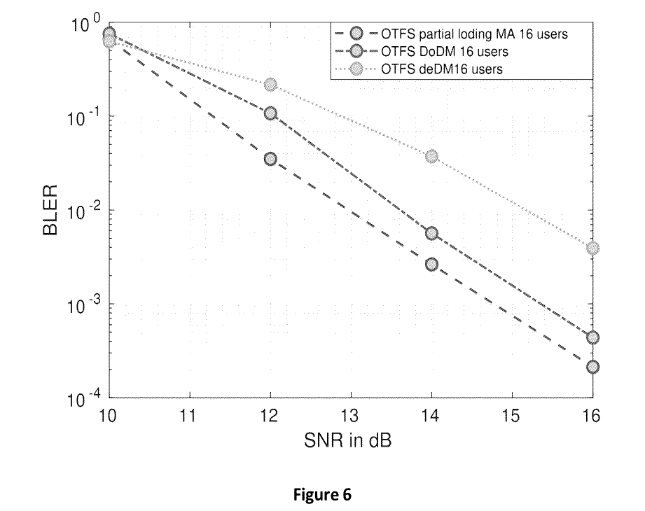

FIG. 6 illustrates a block error rate (BLER) achieved by the receiver of the present disclosure for three different multiple access (MA) schemes with OTFS: a partial loading-based multiple access scheme, Doppler-division multiple access (DoDM), and delay-division multiple access (deDM), in accordance with an embodiment of the present disclosure.

The number of users is kept at 16, with each user transmitting an equal number of data QAM symbols. The main simulation parameters are provided in Table 2.

TABLE 2

| Carrier frequency | 4 | GHz |
|---|---|---|
| M′ × N′ | 512 × 16 | |
| Δf | 15 | kHz |
| Modulation | 16-QAM | |
| FEC | LDPC [4] | |
| Code rate | ½ | |
| Code block length (Cₗ) | 648 | |
| Channel | EVA [5] | |
| delay spread | 2.51 | μs |
| lₘₐₓ | 19 | |
| Velocity | 500 | kmph |

| | |
|---|---|
| Max No. of SIC iterations (Q) | 10 |

For these three MA schemes, the individual user transmissions are modeled with equation (2), where a different semi-orthogonal matrix Jᵤ is formed for the u^{th} user depending on the allocated resources as per the given MA scheme.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limited, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

While various aspects and embodiments have been disclosed herein, other aspects and embodiment will be apparent to those skilled in the art.

### Advantages of the Present Disclosure

The FEC based SIC receiver for multi-user uplink transmission offers several advantages over conventional receivers. The advantages are as follows:
The receiver of the present disclosure may operate even when the individual user transmits different numbers of data symbols according to their needs. Therefore, it can support a range of users, from Internet of Things (IoT) sensor devices that transmit fewer symbols to broadband user devices that require high data rates.
The MMSE operation complexity is proportional to the number of users and their transmitted symbols. Therefore, when only a few users are present and fewer data symbols are transmitted, the receiver operation can be achieved with very low complexity.
As size of the effective channel matrix varies based on length of received signal and MA scheme, therefore, if the SIC-based multi-user uplink receiver 200 receives signal of short length, the processing time and complexity are getting decreased proportionally.

In the detailed description of the embodiments of the disclosure, reference is made to the accompanying drawings that form a part hereof, and which are shown by way of illustration-specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The description is, therefore, not to be taken in a limiting sense.

We claim:

1. A method of successive interference cancellation (SIC) in a multi-user uplink receiver, the method comprises:
receiving (302), by a plurality of antennas (202.1, . . . , 202.R) of the multi-user uplink receiver (200) at a base station (100) or access point, signal (y₁, . . . , y_{R}) of one or more multiple-access (MA) scheme waveforms from one or more users (U₁, . . . , U_{U}), wherein the received signal in each antenna of the plurality of antennas (202.1, . . . , 202.R) relates to a composite signal from one or more users;
determining (304) one or more effective channel matrices (H_{eff,r}) corresponding to the plurality of antennas (202.1, . . . , 202.R), wherein each of the one or more effective channel matrices (H_{eff,r}) for a corresponding antenna of the plurality of antennas (202.1, . . . , 202.R) is determined based on a type of the MA scheme waveforms from the one or more users in the corresponding antenna, and a length of the received signal in the corresponding antenna from the one or more users;
performing (306), by a channel equalization technique using each of the one or more effective channel matrices, channel equalization for signal received in the corresponding antenna from one or more users;
combining (308), using an Equal Gain Combining (EGC) technique, channel equalized signal from the plurality of antennas to form a combined estimated effective transmission signal from the one or more users;
detecting (310) Correctly Decoded Code Blocks (CCBs) and Wrongly Decoded Code Blocks (WCBs) of the received signal from each user of the one or more users; and
performing (312) the SIC on received signals from one or more users until all WCBs are converted to CCBs or a maximum number of threshold iterations are completed.

2. The method as claimed in claim 1, wherein detecting (310) CCBs and WCBs of each user further comprises:
performing (402) segregation on the EGC combined channel equalized signals to retrieve effective symbol vector transmitted by the corresponding user;
computing (404) Log Likelihood Ratio (LLR) values from the retrieved symbol vector upon performing segregation on the EGC combined channel equalized signals;
decoding (406), by a Low-Density Parity-Check (LDPC) decoder, each bit of the LLR values to retrieve code blocks transmitted by the corresponding user;
upon decoding each bit of the LLR values, identifying (408) the CCBs and the WCBs based on the LDPC decoded values for each user; and
regenerating (410) the transmitted data symbol vector using the CCBs for each user for performing SIC in next iteration.

3. The method as claimed in claim 2, wherein performing (312) the SIC on received signals in each of subsequent iterations further comprises:
computing (502) the regenerated data symbol vector for each user to form a regenerated effective symbol vector;
generating (504) a signal for cancelling interference in the corresponding received signal at each antenna by applying a corresponding effective channel matrix among the one or more effective channel matrices to the regenerated effective symbol vector in each subsequent iteration, wherein the corresponding effective channel matrix relates to a channel effect during transmission of the wireless signal;
cancelling (506), by subtracting the generated signal from the received signal, interference from data symbols of the received signal;
updating (508) a corresponding channel equalization matrix based on the corresponding effective channel matrix and the data symbols of the regenerated effective symbol vector upon cancelling the interference;
performing (510), by the channel equalization technique using the updated corresponding channel equalization matrix, channel equalization on interference free signal of each antenna for correcting code blocks in the received signal;
combining (512), using the EGC technique, channel equalized signal from each antenna of the one or more antennas to form interference free combined estimated effective transmission signal from the one or more users;
performing (514) segregation on the EGC combined channel equalized signals to retrieve effective symbol vector transmitted by the corresponding user;
computing (516) LLR values from the retrieved symbol vector upon performing segregation on the EGC combined channel equalized signals;
decoding (518) selectively, by the LDPC decoder, each bit of the LLR values corresponding to the WCBs of the previous iteration to retrieve all code blocks transmitted by the corresponding user;
upon decoding each bit of the LLR values corresponding to the WCBs of the previous iteration, identifying (520) the CCBs and the WCBs based on the LDPC decoded values for each user; and
regenerating (520) data symbols in transmitted data symbol vector by the one or more users from each bit of correctly decoded blocks in combination with previously detected CCBs, wherein the data symbol vector comprises data symbols regenerated from CCBs and zero symbols for corresponding positions of WCBs.

4. The method as claimed in claim 3, wherein the corresponding channel equalization matrix is updated by nullifying columns of the effective channel matrix whose indices match with reconstructed Quadrature Amplitude Modulation (QAM) symbols in the regenerated effective symbol vector.

5. The method as claimed in claim 4, wherein a semi-orthogonal matrix is used for transmitting QAM symbols as per allocated resources during transmission of the wireless signal, wherein the semi-orthogonal matrix is pre-defined based on the type of MA scheme.

6. The method as claimed in claim 1, wherein receiving wireless signal of the one or more MA scheme waveforms further comprises removing cyclic prefix from the received wireless signals for further processing.

7. The method as claimed in claim 1, wherein determining (304) one or more effective channel matrices corresponding to one or more receive antennas further comprises:
generating an upsampling matrix, a cyclic forward permutation matrix, and a rectangular matrix with ones on the main diagonal axis and zeros elsewhere based on type of MA scheme and a number of symbols transmitted by the corresponding user; and
determining one or more effective channel matrices based on the upsampling matrix, the cyclic forward permutation matrix, and the rectangular matrix.

8. The method as claimed in claim 7, wherein size of the one or more effective channel matrices vary based on maximum number of symbols transmitted by a user among one or more users and total number of users transmitting signal to the plurality of antennas.

9. The method as claimed in claim 1, wherein the one or more MA scheme waveforms relate to any one of Orthogonal Time Frequency Space (OTFS), Orthogonal Frequency Division Multiplexing (OFDM), Orthogonal Time-Space Multiplexing (OTSM), or Block Single Carrier (SC).

10. A successive interference cancellation (SIC) based multi-user uplink receiver (200) comprising:
a plurality of antennas (202.1, . . . , 202.R) configured for receiving analog wireless signal from one or more transmitters corresponding to one or more users;
a plurality of analog-to-digital converter (ADC) devices (204.1, . . . , 204.R) for converting analog wireless signals to corresponding digital signals;
at least one processor (206) communicatively coupled with the one or more antennas (202.1, . . . , 202.R) and the plurality of ADC devices (204.1, . . . , 204.R), the at least one processor (206) is configured to:
receive, by the plurality of antennas (202.1, . . . , 202.R) of the multi-user uplink receiver (200) at a base station (100) or access point, signal of one or more multiple-access (MA) scheme waveforms from one or more users, wherein the received signal in each antenna of the plurality of antenna relates to a composite signal from one or more users;
determine one or more effective channel matrices corresponding to the plurality of antennas (202.1, . . . , 202.R), wherein each of the one or more effective channel matrices for a corresponding antenna of the plurality of antennas (202.1, . . . , 202.R) is determined based on a type of the MA scheme waveforms from the one or more users in the corresponding antenna, and a length of received signal in the corresponding antenna from the one or more users;
perform, by a channel equalization technique using each of the one or more effective channel matrices, channel equalization for signal received in the corresponding antenna from one or more users;
combine, using an Equal Gain Combining (EGC) technique, channel equalized signal from the plurality of antennas (202.1, . . . , 202.R) to form a combined estimated effective transmission signal from the one or more users;
detect Correctly Decoded Code Blocks (CCBs) and Wrongly Decoded Code Blocks (WCBs) of the received signal from each user of the one or more users; and
perform the SIC on received signals from one or more users until all WCBs are converted to CCBs in or a maximum number of threshold iterations are completed.

11. The SIC-based multi-user uplink receiver (200) as claimed in claim 10, wherein to detect CCBs and WCBs of each user, the at least one processor (206) is configured to:
perform segregation on the EGC combined channel equalized signals to retrieve effective symbol vector transmitted by the corresponding user;
compute Log Likelihood Ratio (LLR) values from the retrieved symbol vector upon performing segregation on the EGC combined channel equalized signals;
decode, by a Low-Density Parity-Check (LDPC) decoder, each bit of the LLR values to retrieve code blocks transmitted by the corresponding user;
upon decode each bit of the LLR values, identify the CCBs and the WCBs based on the LDPC decoded values for each user; and
regenerate the transmitted data symbol vector using the CCBs for each user for performing SIC in next iteration.

12. The SIC-based multi-user uplink receiver as claimed in claim 11, wherein to regenerate the transmitted data symbol vector by using the CCBs in each of subsequent iterations, the at least one processor (206) is configured to:
compute the regenerated symbol vector for each user to form a regenerated effective symbol vector;
generate a signal for cancelling interference in the corresponding received signal at each antenna by applying a corresponding effective channel matrix to the regenerated effective symbol vector in each subsequent iteration, wherein the corresponding effective channel matrix relates to a channel effect during transmission of the wireless signal;
cancel, by subtracting the generated signal from the received signal, interference from data symbols of the received signal;
update the corresponding channel equalization matrix based on the data symbols of the regenerated effective symbol vector upon cancelling the interference;
perform, by the channel equalization technique using the updated corresponding channel equalization matrix, channel equalization on interference free signal of each antenna for correcting code blocks in the received signal;
combine, using the EGC technique, channel equalized signal from each antenna of the one or more antennas to form interference free combined estimated effective transmission signal from the one or more users;
perform segregation on the EGC combined channel equalized signals to retrieve effective symbol vector transmitted by the corresponding user;
compute LLR values from the retrieved symbol vector upon performing segregation on the EGC combined channel equalized signals;
decode selectively, by the LDPC decoder, each bit of the LLR values corresponding to the WCBs of the previous iteration to retrieve all code blocks transmitted by the corresponding user;
upon decoding each bit of the LLR values corresponding to the WCBs of the previous iteration, identify the CCBs and the WCBs based on the LDPC decoded values for each user; and
regenerate data symbols in the transmitted data symbol vector by the one or more users from each bit of correctly decoded blocks in combination with previously detected CCBs.

13. The SIC-based multi-user uplink receiver (200) as claimed in claim 10, to determine one or more effective channel matrices corresponding to one or more receive antennas, the at least one processor (206) is further configured to:
generate an upsampling matrix, a cyclic forward permutation matrix, and a rectangular matrix with ones on the main diagonal axis and zeros elsewhere based on type of MA scheme and a number of symbols transmitted by the corresponding user; and
determine one or more effective channel matrices based on the upsampling matrix, the cyclic forward permutation matrix, and the rectangular matrix.

14. The SIC-based multi-user uplink receiver (200) as claimed in claim 10, wherein size of the one or more effective channel matrices vary based on maximum number of symbols transmitted by a user among one or more users and total number of users transmitting signal to the plurality of antennas.
